(19) United States
(12) Patent Application Publication
(10) Pub. No.: US 2019/0005844 A1
(43) Pub. Date: Jan. 3, 2019

(54) SYSTEM AND METHOD FOR IDENTIFYING AND MODIFYING BEHAVIOR

(71) Applicant: PLAYTECH SERVICES (CYPRUS) LIMITED, Nicosia (CY)

(72) Inventors: Simo DRAGICEVIC, Sutton (GB); Robert William BROWN, Edenbridge (GB); Christian William PERCY, London (GB)

(73) Assignee: PLAYTECH SERVICES (CYPRUS) LIMITED, Nicosia (CY)

(21) Appl. No.: 16/125,215

(22) Filed: Sep. 7, 2018

Related U.S. Application Data
(63) Continuation-in-part of application No. 14/926,391, filed on Oct. 29, 2015, now abandoned.
(60) Provisional application No. 62/073,054, filed on Oct. 31, 2014.

(51) Int. Cl. G09B 19/00; G09B 7/00

(52) U.S. Cl. CPC G09B 19/00; G09B 7/00

(57) ABSTRACT

There are provided method and system for identifying and modifying behavior. The method comprises: receiving information relating to a first user's behavior; analyzing the first behavior information to identify first behavioral risk indicators indicative of statistically significant changes in behavior of the first user; and when the identified first behavioral risk indicators meet predefined risk criteria, initiating actions configured to cause the first user to change behavior in the risk activity. The method can further comprise: identifying second users with existing similarity between respective second behavior information and the first behavior information; obtaining averaged behavioral risk indicators indicative of averaged statistically significant changes in behavior of the identified second users; and assessing the first behavioral risk indicators as meeting the predefined risk criteria in accordance with similarities between the first behavioral risk indicators and the averaged behavioral risk indicators.

This is a Continuation-in-Part of application Ser. No. 14/926,391 filed Oct. 29, 2015, which claims the benefit of U.S. Provisional Application No. 62/073,054 filed Oct. 31, 2014. The disclosure of the prior applications is hereby incorporated by reference herein in its entirety.

### FIELD

This specification relates generally to a system and method for identifying and modifying behavior in a risk activity.

### BACKGROUND

The popularity of gambling is increasing due to factors such as increased gambling expansion though the liberalisation and regulation of gambling markets, as well as the proliferation of new electronic consumer channels for participation. These increased opportunities to participate serve to heighten concerns about the potential for gambling related harm. Likewise, there is also increasing concerns with regards to harm minimization and consumer protection in other industries such as social gaming, trading and investment, alcohol, tobacco and food.

### SUMMARY

In accordance with certain aspects of the presently disclosed subject matter, there is provided a method provided by a computer and comprising: receiving information relating to a first user's behavior, thereby giving rise to a first behavior information; analyzing the first behavior information to identify one or more first behavioral risk indicators indicative of statistically significant changes in behavior of the first user; and when the identified one or more first behavioral risk indicators meet predefined risk criteria, initiating one or more actions configured to cause the first user to change behavior in the risk activity.

The identified one or more first behavioral risk indicators can be used to determine likelihood of the first user exhibiting the behavior in the risk activity being above a threshold likelihood.

Initiating the one or more actions may comprise enabling the first user to be provided with one or more messages configured to cause the first user to change their behavior in the risk activity. Moreover, the one or more messages and/or other actions can be configured based on the determined likelihood of the first user exhibiting the behavior in the risk activity and/or the one or more behavioral risk indicators.

In accordance with further aspects, the method can further comprise: obtaining one or more at-risk behavioral risk indicators indicative of statistically significant changes in behavior of a second user considered as being at-risk; and assessing the first behavioral risk indicators as meeting the predefined risk criteria when exist similarities between the first behavioral risk indicators and the at-risk behavioral risk indicators. Alternatively or additionally, the method can further comprise: obtaining one or more averaged at-risk behavioral risk indicators indicative of averaged statistically significant changes in behavior of one or more users considered as being at-risk; and assessing the first behavioral risk indicators as meeting the predefined risk criteria when exist similarities between the first behavioral risk indicators and the averaged at-risk behavioral risk indicators.

In accordance with further aspects, the method can further comprise identifying, among the one or more of users considered as being at-risk, users with similarities in demographic information with the first user's; and obtaining the one or more averaged at-risk behavioral risk indicators by averaging over behavior information related merely to the identified users.

In accordance with further aspects, the method can further comprise: receiving second behavior-relating information for each user from a plurality of users; identifying, among the plurality of users, one or more second users with existing similarity between respective second behavior information and the first behavior information; obtaining one or more averaged behavioral risk indicators indicative of averaged statistically significant changes in behavior of the identified one or more second users; and assessing the first behavioral risk indicators as meeting the predefined risk criteria in accordance with similarities between the first behavioral risk indicators and the averaged behavioral risk indicators.

In accordance with further aspects, the method can further comprise: receiving from the first user responses on one or more questions; identifying one or more second users with existing similarity between their stored responses on the same one or more questions and the respective responses from the first user; obtaining one or more averaged behavioral risk indicators indicative of averaged statistically significant changes in behavior of the identified one or more second users; and assessing the first behavioral risk indicators as meeting the predefined risk criteria in accordance with similarities between the first behavioral risk indicators and the averaged behavioral risk indicators.

In accordance with other aspects of the presently disclosed subject matter, there is provided an apparatus comprising at least one processing device operatively connected to at least one memory, the processing device and the memory configured to: receive information relating to a first user's behavior, thereby giving rise to a first behavior information; analyze the first behavior information to identify one or more first behavioral risk indicators indicative of statistically significant changes in behavior of the first user; and when the identified one or more first behavioral risk indicators meet predefined risk criteria, initiate one or more actions configured to cause the first user to change behavior in the risk activity.

In accordance with other aspects of the presently disclosed subject matter, there is provided a non-transitory computer readable medium comprising instructions that, when executed by a processing device, cause the processing device to: receive information relating to a first user's behavior, thereby giving rise to a first behavior information; analyze the first behavior information to identify one or more first behavioral risk indicators indicative of statistically significant changes in behavior of the first user; and when the identified one or more first behavioral risk indicators meet predefined risk criteria, initiate one or more actions configured to cause the first user to change behavior in the risk activity.

In accordance with other aspects of the presently disclosed subject matter, there is provided a method comprises: receiving information relating to a first user's behavior; analyzing the behavior information to identify one or more behavioral risk indicators comprising statistically significant behavioral changes; determining one or more similarities between the first user's behavior information and stored information relating to the behavior of one or more second users; based on the one or more determined similarities, determining a likelihood of the first user exhibiting a behavior in a risk activity which was exhibited by the one or more second users; and initiating one or more actions configured to cause the first user to change their behavior in the risk activity. Determining one or more similarities between the first user's behavior information and stored information relating to the behavior of one or more second users may comprise determining similarities between the identified one or more behavioral risk indicators and behavioral risk indicators associated with the one or more second users.

Moreover, the method may further comprise receiving non-behavioral information relating to the first user; and determining one or more similarities between the first user's non-behavioral information and stored non-behavioral information relating to the one or more second users.

Furthermore, determining the likelihood of the first user exhibiting a behavior in a risk activity which was exhibited by the one or more second users may also be based on the determined one or more similarities between the first user's non-behavioral information and non-behavioral information relating the one or more second users.

In accordance with other aspects of the presently disclosed subject matter, there is provided a method of therapy for an individual with a problem gambling disorder comprises: receiving information relating to a first user's behavior; analyzing the behavior information to identify one or more behavioral risk indicators comprising statistically significant behavioral changes; determining one or more similarities between the first user's behavior information and stored information relating to the behavior of one or more second users; based on the one or more determined similarities, determining a likelihood of the first user exhibiting a behavior in a risk activity which was exhibited by the one or more second users; and initiating one or more actions configured to cause the first user to change their behavior in the risk activity.

Thus, the presently disclosed technique enables assessing risk activity based on monitoring statistically significant changes of user's own behavior with no need in reference model derived from behavior of other users. Thereby, the presently disclosed technique enables increasing credibility of behavior data analysis and, thus, initiating more appropriate actions to cause the behavior changes in the risk activity. Furthermore, the presently disclosed technique enables identifying discrete sessions of play, thereby assessing risk activity in anonymous play sessions.

### BRIEF DESCRIPTION OF THE DRAWINGS

For a more complete understanding of example embodiments of the present invention, reference is now made to the following description taken in connection with the accompanying drawings in which:

FIG. 1 is a schematic illustration of a system in which the likelihood of a gambler's betting activities becoming unsustainable is assessed;

FIG. 2 is a flow chart of functions performed by the assessment server of FIG. 1;

FIG. 3 is a flow chart of functions performed by the assessment server of FIG. 1; and

FIG. 4 illustrates operation of the system 1 of FIG. 1 with regard to anonymous play.

### DETAILED DESCRIPTION OF THE EXAMPLE EMBODIMENTS

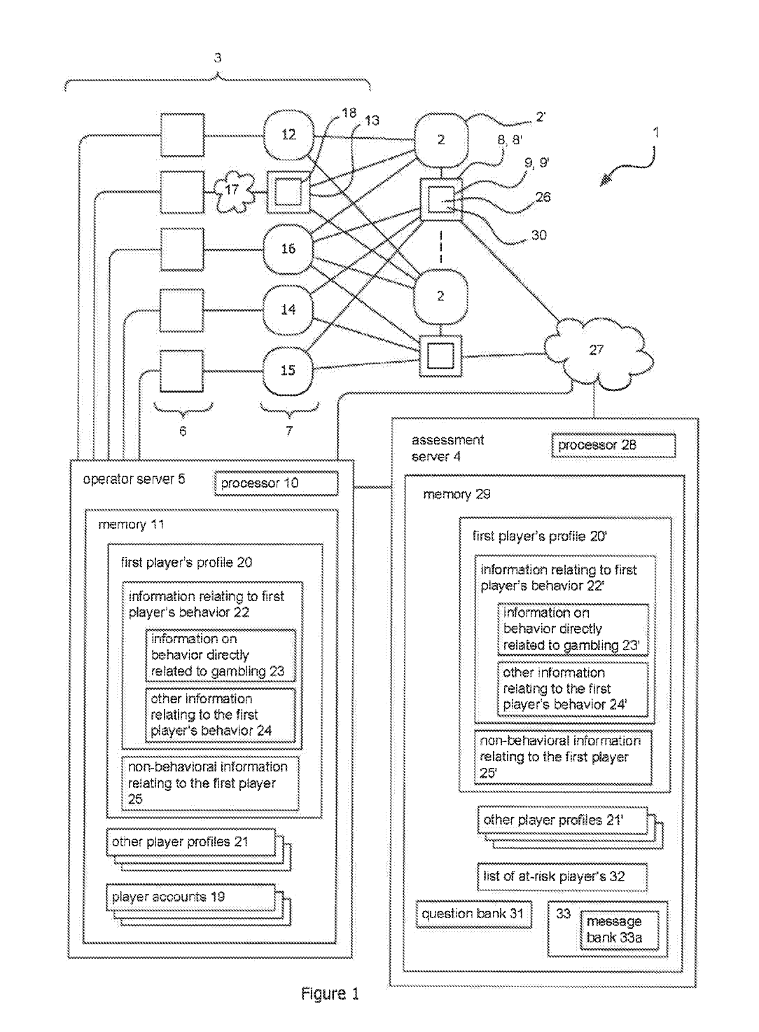

Referring to FIG. 1, a system 1 is illustrated which assesses the behavior of one or more entities engaging in gambling activities (e.g. one or more players 2).

The system 1 comprises a gambling system 3 of a gambling operator and an assessment server 4. The gambling system 3 comprises an operator server 5, a plurality of service servers 6 and a plurality of respective gambling services 7. Via the service servers 6, the operator server 5 facilitates provision of the gambling services 7 to the players 2, and receives information relating to each players' behavior as they use the gambling services 7. Each player 2 has access to a respective computing device 8 (e.g. a smart phone, a tablet computer or laptop computer, etc.) comprising a display screen 9. The assessment server 4 receives from the operator server 5 the information relating to the gambling behavior of each of the players 2. The assessment server 4 uses this information to assess the current gambling behavior and determine likely future gambling behavior of each player 2. Moreover, if the assessment server 4 determines that a player 2 is likely to exhibit behaviors associated with problem gambling, then the assessment server initiates one or more actions, comprising enabling the player to be provided with one or more messages, configured to change the player's behaviors so as to avoid the behaviors associated with problem gambling. A more detailed description of the system 1 is provided below.

The operator server 5 comprises a processor 10 and a memory 11. The configuration of the operator server 5 to perform functions described herein comprises configuration of the memory 11 and computer program code stored therein to cause the operator server 5 to perform the functions.

The gambling services 7 comprise casino kiosks 12, gaming machines 13 (e.g. electronic gaming machines (EGM), video lottery terminals (VLT), etc.) linked to the operator server 5, internet gambling games and services 14 accessed by players via their respective computing devices 8, and SMS, cellular and email based gambling services 15 accessed by players via their respective computing devices 8. Other types 16 of gambling services 6 are also possible, such as gambling services provided via Digital Television.

One or more of the gaming machines 13 are managed by their respective service server 6 over a distributed wireless network 17, such as a LAN or WAN. The EGMs and VLTs each comprise a display 18 for communicating information to a player 2 making use of them.

The memory comprises a plurality of player accounts 19, comprising a player account 19 for each of the players 2 that make use, or have previously made use, of the gambling services 7. A player's account 19 comprises administrative information regarding the player 2, such as registration information relating to the player's registration for use of the gambling services 7, information used to identify the player 2, financial information related to the player 2 and the player's responsible gambling settings. For example, the financial information relating to the player 2 comprises information relating to how the player 2 deposits real money in their account 19, which includes information on the sources of deposits (e.g. credit cards, debit cards, etc) and any limits to these deposits.

Moreover, the player's responsible gambling settings comprise information on any gambling limits or restrictions voluntarily set by the player 2 or instigated by the system 1, such as loss limits.

The memory 1 comprises a plurality of player profiles 20, 21, wherein each player profile 20, 21 is associated with one of the one or more players 2 that make use, or have previously made use, of the gambling services 7. The player profile 20 of a first player 2′ of the plurality of players 2 is illustrated, and is herein referred to as the first player's profile 20. As is illustrated with reference to the first player's profile 20, each player profile 20, 21 comprises information 22 relating to that player's behavior, comprising information 23 on behavior of the player that is directly related to gambling and other information 24 relating to the player's behavior. Moreover, each player profile 20, 21 comprises non-behavioral information 25 relating to the player.

For example, the information 23 on behavior of a player that is directly related to gambling may comprise:
information identifying which gambling services have been used by the player;
information identifying which game types have been played by the player via the gambling services;
the date, time, frequency and duration of each session of gambling by the player;
the date, time, frequency and duration of each game played by the player within a session of gambling;
the number, timing, frequency and size of bets made by the player;
the number, timing, frequency and size of wins and/or losses experienced by the player;
information identifying the financial deposit source used by the player for placing bets and the timing of any changes to this;
information on the player's betting behavior using both money from the player's one or more deposits and any gifted or bonus money provided to the player by the gambling system 3;
information on instances of the player attempting to place bets which exceed the funds available to them through a chosen deposit source, resulting in a rejection of the bet by the deposit source;
information on changes to the player's deposit limits
information on changes by the player to their gambling limits such as their loss limit, or self-exclusion start/end date; and/or
information identifying the nature of bets made by the player, such as the timescale of bets made—for example, information indicating how long a bet made will take to conclude.

This information 23 is received by the operator server 5 in the course of a player's usage of the services. For example, when players 2 use the gambling services 7, their gambling behaviors are received and recorded by the operator server 5 in their respective player profiles 20, 21. The information 23 on behavior of a player 2 that is directly related to gambling may also in part be received at the operator server 5 from third party sources, such as from other gambling systems.

Moreover, the other information 24 relating to a player's behavior may for example comprise the player's credit score, and/or information on variations in the player's credit score over time, and information on communications that have occurred between the player 2 and the gambling operator. For example, the information on communications between the player 2 and the gambling operator may relate to communications via a range of mediums such as phone, email, website interactions, text message and conversations in person between staff of the gambling operator and the player. For example, the information on communications between the player and the gambling operator may comprise information based on customer services telephone conversations, which may include information on the tone of the player's communication. The information on communications may also comprise click-stream information from the player's use of internet websites and services, including those of the gambling services 7, provided by the gambling operator 3.

The non-behavioral information 25 relating to a player may comprise for example demographic information such as the gender and date of birth of the player 2, information on the player 2 derived through social media, information identifying a marketing segment to which the player 2 has been determined as belonging to, information from medical records of the player 2 (subject to the consent of the player) and/or question responses provided by the player 2 in response to questions provisioned to the player by the assessment server 4.

The operator server 5 is configured to provide a network portal 26, such as a webpage, which is accessible by each of the one or more players 2 via a network 27 using the computing devices 8, 8′ of the players. The network portal 26 enables communications with players 2 and allows players 2 to set and adjust parameters of their player accounts stored on the gambling system 3, such as setting self-imposed betting limits or initiating a self-exclusion period. When a player 2 alters these gambling parameters, this behavior is stored in the player's respective player profile 20, 21 as information 23 on behavior directly related to gambling.

The operator server 5 is configured to communicate with the assessment server 4. Moreover, the operator server 5 is configured to send a copy 20′, 21′ of each of the player profiles 20, 21 to the assessment server 4, once this data is recorded at the operator server 5.

The assessment server 4 comprises a processor 28 and a memory 29. The configuration of the assessment server 4 to perform functions described herein comprises configuration of the memory 29 and computer program code stored therein to cause the assessment server 4 to perform the functions.

The assessment server 4 is configured to provide a network portal 30 that is fully integrated with the operator network portal 26. For example, this integration may be achieved using application programming interfaces. The network portal 30 provided by the assessment server 4 facilitates communication between the assessment server 4 and each player 2, via the computing device 8 of each player.

The memory 29 comprises the player profiles 20′, 21′ received from the operator server 5.

The memory 29 also comprises a question bank 31 of questions for provision to players 2 via the network portal 26, 30 in order to assess their gambling behavior and whether they are experiencing harm as a result of their gambling. The questions may, for example, relate to a player's 2 perception of their gambling behavior, their perception of the personal and social consequences of their gambling behavior and their perception of the amount of time they spend gambling. In other words, the questions can provide a self-test or self-assessment to enable the assessment server 4 to capture the views of a player 2 in relation to whether they are potentially experiencing harm from their gambling activities. For example, the questions may be those of one of the standard assessment used by clinicians, such the Diagnostic and Statistical Manual for Mental Disorders, Fifth Edition (DSM-V), the Problem Gambling Severity Index (PGSI), the Canadian Problem Gambling Index (CPGI), the South Oaks Gambling Screen (SOGS), or any other proprietary or variations on these or other self-tests or assessments. The network portal 26, 30 is configured to allow a player 2 to answer the questions via a graphic user interface, displayed on the display 9 of their computing devices 8, such that the player's answers are sent back to the assessment server 4. Question answers received by the assessment server 4 from each player 2 are stored as non-behavioral information 25 relating to a player in the player's respective player profile 20′, 21′, and are sent to the operator server 5 for duplicate storage in the player's profile 20, 21 there.

The memory 29 also comprises a list 32 of players 2 considered to be at-risk of having or developing a gambling problem. These players are referred to herein as at-risk players. Self-exclusion is an extreme form of pre-commitment, in which gamblers who believe that they have a problem can voluntarily bar themselves from being able to use one or more gambling services provided by a gambling operator for a period of time. The system 1 uses the act of self-exclusion by a player as a proxy, or indicator, for the player being at-risk. If a player 2 self-excludes, this is recorded by the assessment server 4, and information indicating the player 2, such as information indicating the player's profile 20′, 21′, is entered into the list of at-risk players 32.

The memory 29 also comprises an action bank 33 configured to facilitate the initiation by the assessment server 4 of one or more actions configured to change a player's behaviors so as to avoid the player self-excluding. In this respect, the action bank 33 comprises a message bank 33a of messages for provision to players 2 via the network portal 26, 30. The messages are intended to educate players 2 regarding their respective gambling behaviors and to thereby therapeutically encourage help them to make informed decisions regarding future gambling. For example, the messages may include tips to enable players 2 to modify their play should it show signs of developing towards self-exclusion. In this respect the message bank 33a comprises a spectrum of messages each tailored to address different determined situations concerning a player's 2 gambling behavior.

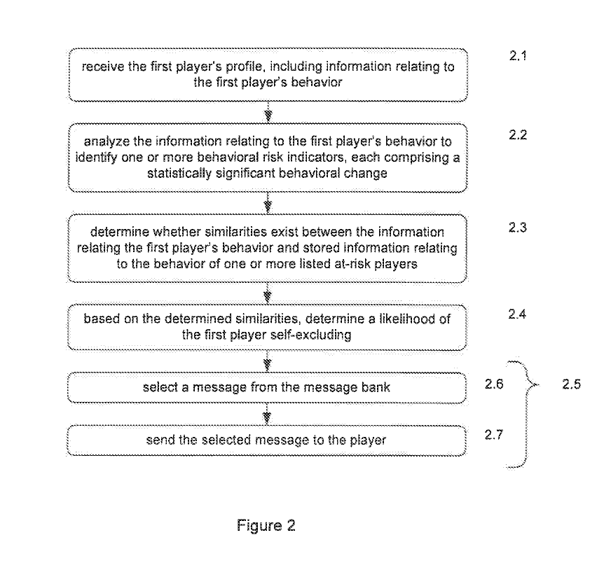

Referring to FIG. 2, operation of the system 1 of FIG. 1 with regard to the first player 2′ is illustrated. The same operation is performed by the system 1 for each of the players 2.

At step 2.1, the assessment server 4 receives from the operator server 5, and stores a copy 20′ of, the first player's profile 20. The assessment server 4 may already have in its memory 29 a first version of the first player's profile 20′, received previously from the operator server 5. In this case, the information received from the operator server 5 at step 2.1 may be an update, comprising information relating to the first player 2′ which was determined subsequent to the provision of the first version to the assessment server 4.

The assessment server 4 can receive data related to the first player's profile 20 by different integration methods. For example this could be in real-time via an application programming interface. For instance, the operator server 5 may send information relating to the first player's behavior as and when it occurs, or it may send this information periodically (e.g. every 5 minutes, hour, day, week, etc.).

Step 2.2 comprises monitoring behavioral change. In more detail, at step 2.2 the assessment server 4 analyzes the information 22′ relating to the first player's behavior, comprising information 23′ on behavior directly related to gambling and other information 24′ relating to the first player's behavior, by identifying behavioral risk indicators indicative of statistically significant behavioral changes considered to be associated with problem gambling. By way of non-limiting example, the assessment server 4 may analyze the information 22′ relating to the first player's behavior to determine whether any of the behavioral risk indicators of Table 1 are present.

TABLE 1

| Behavioral | Behavioral risk | Short description of considered |
|---|---|---|
| dimension | indicator | significance of the risk indicator |
| Bet | Increasing size of bets | Linked to an increasing need to |
| patterns | | gamble and to spend increasingly |
| | | more money |
| | Increasing bet | Linked to loss-chasing and/or |
| | variability Increasing | overconfidence. Linked to an |
| | bet frequency | increasing need to gamble and/or |
| | | tolerance |
| | Increase in ratio of | Linked to loss-chasing |
| | post-loss bet size | |
| | versus post-win bet | |
| | size | |
| | Increase in ratio of | Linked to loss-chasing |
| | post-loss bet frequency | |
| | versus post-win bet | |
| | frequency | |
| | Increase in ratio of | A potential sign of problem |
| | short-term bets versus | gambling and could be correlated |
| | long-term bets | to other risk factors e.g, |
| | | increasing size of bets and/or |
| | | increasing bet variability |
| | Significant size or | Problem gambling often results |
| | number of wins early | when a player wins a lot at the |
| | in a period of playing | start of their betting on a new |
| | a new type of game | type of game |
| | High Theoretical Loss | Linked to increasing need to |
| | Risk | gamble and spend on games of |
| | | chance where the probability of |
| | | the casino operator taking a |
| | | higher proportion of stake is |
| | | higher (e.g. return to player |
| | | lower than 80%, for example) |
| | | compared to other games. |
| Bet/spend | Significant ratio | Problem gambling often results |
| patterns | between amount of | when a player wins a lot at the |
| | money won early in a | start of their betting on a new |
| | period of playing an | type of game |
| | new type of game to | |
| | amount of game money | |
| | deposited | |
| Spend | Increasing number | Linked to negative financial |
| patterns | and/or of losses | consequences Linked to |
| | Increase in deposit | unsustainable gambling |
| | required to finance | |
| | gambling | |
| | Increasingly using | Linked to unsustainable gambling |
| | credit to finance | |
| | gambling | |
| | Decline in a player's | Can be a sign of potentially |
| | credit score | problematic behavior, for example |
| | | when combined with increasing |
| | | use of credit to finance gambling |
| | | and/or and increasing size of bets |
| | Changing to a different | Linked to excessive gambling, |
| | deposit source at the | particularly if increase in the |
| | end of the month(e.g. | deposit required to finance a |
| | from coupled with a | player's gambling |
| | debit card to credit | |
| | card) | |
| | An increase in the | Deposit rejections can be a signal |
| | frequency of deposit | of someone trying to gamble |
| | rejections | beyond their financial means |
| | Decrease or removal of | Evidence that a player is needing |
| | deposit and/or wager | to increase their gambling involve- |
| | limits | ment from previous levels |
| | Self-exclusion history | Previous evidence of using cooling |
| | | off and self- exclusion features |
| | | could be an indication that the |
| | | player has a gambling problem |
| Play | Increase in frequency | Linked to an increasing need to |
| session | of play sessions | gamble and/or tolerance |
| patterns | Increase in total session | Linked to pre-occupation with |
| | time. Irrational | gambling For example, when a |
| | behavior demonstrated | player presses “play” repeatedly |
| | in clickstream | while waiting for a system |
| | | response |
| | Increase in the number | Evidence suggests that problem |
| | of gaming verticals | gamblers often participate in |
| | (e.g. lottery, casino, | multiple forms of gambling. |
| | poker, bingo) played, | |
| | Increase game modes | Evidence suggests that problem |
| | (e.g. internet gambling, | gamblers often participate in |
| | land-based gambling) | multiple game modes |
| | played | |
| | Increase in the amount | Evidence suggests there could |
| | of gambling taking | be possible negative social |
| | place at night (e.g. | consequences as result of |
| | between a 11 pm and 4 | disruptive sleep patterns |
| | am) | |
| Communi- | Increasing frequency of | Evidence suggests this is a sign |
| cation | player interaction with | of potential problem gambling |
| patterns | customer services | behaviors |
| | Tonality Indicator | These are possible signs that |
| | | someone is no longer gambling |
| | | for fun and is experiencing |
| | | negative consequences |

The assessment server 4 analyses whether player's behavior changes are occurring randomly or they are likely to be attributable to a specific cause. Thus, behavioral risk indicators are indicative of behavioral changes characterized by statistically significance meeting a predefined significance threshold. Such changes are referred to hereinafter as statistically significant behavioral changes. By way of non-limiting example, the significance threshold for statistical significance can be predefined between 90% (somewhat confident) and 99% (very confident). It is noted that the significance threshold for statistical significance (and, accordingly, for the changes considered as statistically significant) can differ for different behavior patterns. By way of non-limiting example, for spend pattern the significance threshold can be settled as >90%, while for play pattern the significance threshold can be settled as >95%, etc.

Following the non-limiting examples in Table 1, behavioral risk indicators can be identified by analyzing the following risk factors and/or combinations thereof:
trajectory risk factor indicative of increasing player's spending over time;
session time risk factor indicative of increasing game time;
frequency risk factor indicative of increasing returns to play;
intensity risk factor indicative of increasing wagers or bets;
variability risk factor indicative of increasing variability of wagers or bets, etc.

By way of non-limiting example, behavioral risk indicators can be derived from the data informative of one or more risk factors by statistical analyses thereof. Initial behavioral risk indicators can be identified through a diverse range of statistical tests e.g., linear regression, t-tests, Browne-Forsythe tests, and alike, wherein the results of those tests are used as inputs into the machine learning technique to provide more complex patterns of behavior against which to map known player outcomes. For example:
by calculating the player's daily bet amount and plotting these points over a pre-defined and configurable period of active gambling days and calendar days, a linear regression can provide a p-value and slope co-efficient to indicate whether the individual behavior has demonstrated a consistent trend over that period;
by calculating average player wagering volumes for prior and current periods and comparing differences using t-tests, also over a pre-defined and configurable period of active gambling days and calendar days, this can provide a p-value to indicate whether a current period has witnessed a statically significant change in behavior compared to a previous period;
variation in amount bet over a period can also be derived as a measure of betting volatility, which can in turn be compared against the variation in previous periods to assess trends and trend consistency via p-values.

The test output, including test metrics like p-values, allow the machine learning technique to consider the consistency of trends as an input alongside absolute levels of activity in recent and prior periods, as well as average trend directions.

Steps 2.3 and 2.4 comprise predicting events related to problem gambling. At step 2.3 the assessment server 4 compares the first player's profile 20′ with player profiles 2′ of players listed 32 as being at-risk to determine whether similarities exist between the information 22′ relating to the first player's behavior and the information relating to the behavior of the at-risk players. If similarities are identified, at step 2.4 the assessment server 4 determines, based on the determined similarities, a probability that the first player 2′ will go on to self-exclude.

It is noted that similarity between two profiles exists when two profiles can be classified (statistically or with the help of machine learning and/or AI techniques) to the same category with classification probability meeting a predefined classification threshold (e.g. between 90% (somewhat confident) and 99% (very confident). The profiles can characterize different players or at least one of the profiles can be an averaged profile of a plurality of players. Classification can be provided in accordance with entire information comprised in the profile, part thereof and/or derivatives thereof. For example, profiles can be considered as similar when statistically classified to the same category based on all or a part of behavioral risk indicators respectively derived from the profiles. When statistically significant difference between the profiles (e.g. defined based on all or a part of behavioral risk indicators respectively derived therefrom) does not meet the classification threshold, the profiles are considered as having no similarity. Optionally, classification of profiles can be provided in several steps, each step having its own classification threshold. For example, profiles can be first classified in a category in accordance with game habits, and further similarity can be defined only for profiles belonging to the same category.

In more detail, at steps 2.3 and 2.4, the assessment server 4 uses logistic regression in analyzing the information 22′ relating to the first player's behavior against the information relating to the behavior of players 2 listed 32 as being at-risk, and thereby determines an estimate of the likelihood of the first player 2′ self-excluding.

At step 2.5, the assessment server 4 initiates one or more actions configured to change the first player's behavior, wherein the one or more actions comprise steps 2.6 and 2.7.

At step 2.6, the assessment server 4 selects a message from the message bank 33a based on the determined likelihood that the first player 2′ will self-exclude. At step 2.7 the assessment server 4 sends the selected message to the first player 2′ via the network portal 26, 30. As a result, the message is displayed on the display 9′ of the first player's device 8′ and viewed there by the first player 2′.

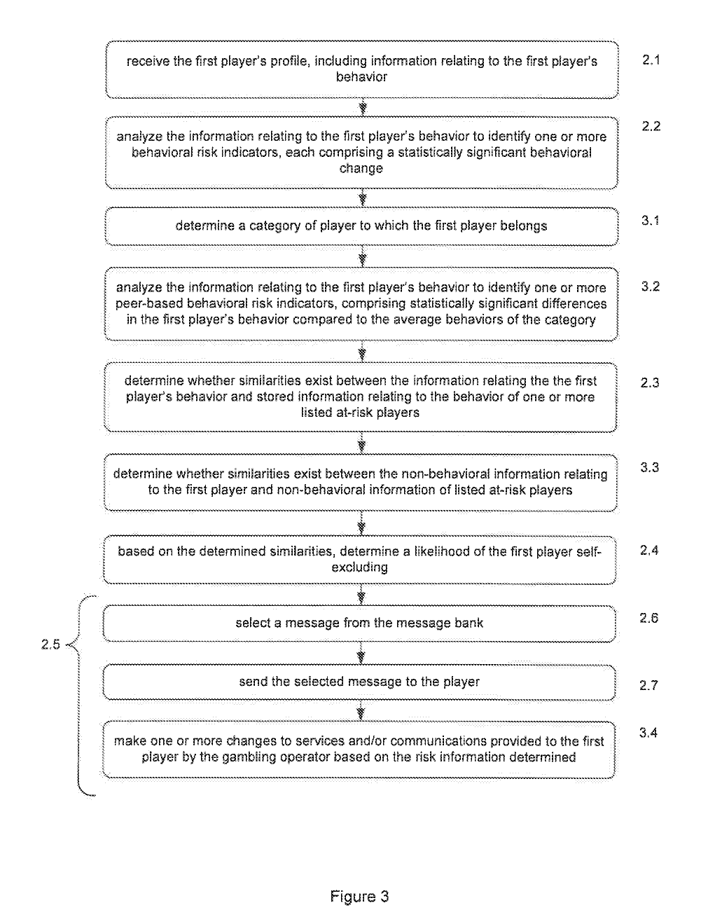

Many alternatives and variations of the embodiments described herein are possible. Example alternatives and variations are described below. In this regard, FIG. 3 illustrates the method of FIG. 2 modified to incorporate some of the variations described below. Method steps of FIG. 3 indicated by reference numerals 2.1 to 2.7 correspond to the method steps of FIG. 2 indicated by the same reference numerals.

The above described displaying of messages to the first player 2′ by sending messages to first player 2′ may also comprise sending messages to the first player 2′ via email or text message (SMS) for display on the display 9′ of the computing device 8′ of the first player 2′. Moreover, messages may be sent to the first player 2′, via the operator server 5, by displaying them on the display screens 18 of the EGMs or VLTs. For example, the network portal 26, 30 may also be available to players 2 via the display screens 18 of the EGMs and VLTs of the gambling system 3. Furthermore, messages may be sent to the first player 2′ by displaying them on any web service, such as the internet gambling games and services 14, provided by the operator server 3, for viewing on the display screen 9′ of the computing device 8′ of the first player 2′.

The assessment server 4 may only initiate the one or more actions at step 2.5 if it determines that the determined likelihood of the first player 2′ self-excluding is above a certain threshold likelihood.

Although the method of FIG. 2 has been described as using the information 22′ relating to the first player's behavior, comprising information 23′ on behavior directly related to gambling and other information 24′ relating to the first player's behavior, the behavioral information 22′ used may instead comprise only the information 23′ on behavior directly related to gambling or only the other information 24′ relating to the first player's behavior.

Step 2.3 may comprise comparing the first player's profile 20′ with player profiles 21′ of player's listed 32 as being at-risk to determine whether similarities exist between the first player's 2′ identified behavioral risk indicators and identified behavioral risk indicators of the at-risk players.

The method of FIG. 2 may further comprise, for example between steps 2.2 and 2.3, the assessment server 4 sending questions from the question bank 31 to the first player 2′ via the network portal 26, 30, and the assessment server 4 then receiving the first player's question responses and storing these in the non-behavioral information 25′ relating to the first player 2′. The sending of the questions to the first player 2′ may occur automatically in response to identification of behavioral risk indicators at step 2.2.

The sending of questions to a player 2 by the assessment server 4 may also or alternatively be initiated at any time voluntarily by the player, for example via an option to take a self-assessment quiz provided by the network portal 26, 30.

The assessment server may select specific questions from the question bank 31 based on the first player's 2′ determined behavioral risk indicators.

Step 2.2 may further comprise assessing the question responses to determine one or more response risk indicators, relating to aspects of the question responses considered to be associated with unsustainable gambling behaviors. For example the one or more response risk indicators may take the form of a response risk score, such as that provided by the PGSI.

Furthermore, step 2.3 may comprise comparing the first player's profile 20′ with player profiles 21′ of player's listed 32 as being at-risk to determine whether similarities exist between the first player's 2′ question responses and/or their identified response risk indicators and the question responses and/or identified response risk indicators of the at-risk players.

As illustrated by step 3.3 of FIG. 3, the method of FIG. 2 may further comprise the assessment server 4 comparing the first player's profile 20′ with player profiles 21′ of player's listed 32 as being at-risk to determine whether similarities exist between the non-behavioral information 25′ relating to the first player 2′ and the non-behavioral information of the at-risk players. For example, step 2.3 may include the identification of similarities between the first player's demographic information and demographic information of one or more of the at-risk players. Step 2.4 may then be based on the similarities determined at step 2.3 and step 2.4.

The method of FIG. 2 may include, as illustrated by step 3.1 of FIG. 3, the assessment server 4 identifying one or more of the other players 2 whose player profiles 21′ share similarities with the first player's profile 20′. For example, this may comprise determining a category of player, based on certain parameters such as playing habits (e.g. trajectory, session time, frequency, intensity, etc.), to which the first player 2′ and a number of the other players 2 belong. This may be achieved through the use of statistical techniques such as statistical classification. It is noted that players can be considered as belonging to the same category in a case of similarity (i.e. statistically significant difference meeting a predefined threshold) in responses on the same questions.

Moreover, the method of FIG. 2 may include, as illustrated by step 3.2 of FIG. 3, the assessment server 4 comparing the first player's profile 20′ with the profiles 21′ of player's belonging to the same category to determine whether any statistically significant difference exist between the information 22′ relating to the behavior of the first player and an average of the information relating to the behavior of each of the other players.

For example, this may comprise determining that a particular aspect of the first player's behavior, such as their betting intensity, is excessive compared to the average behavior of the other players. Such identified statistically significant differences resulting from this normative comparison are treated as behavioral risk indicators, and are referred to herein as peer-based behavioral risk indicators. For example, determining peer-based behavioral risk indicators may comprise determining which percentile the first player's 2′ behaviors lie in within the distribution of behaviors of the other players of the same category. For instance, the first player's betting intensity behavior may be determined as being in the 99^{th} percentile of betting intensity when compared to the betting intensity exhibited by the other players of the same category, and this excessive behavior relative to their category would be identified as a peer-based behavioral risk indicator.

The above described determining of behavioral risk indicators at step 2.2 may comprise utilisation or consideration of the absolute values of the behavioral parameters being analyzed for statistically significant changes over time, or of the absolute values of related behavioral parameters. Similarly, determining of behavioral risk indicators at steps 3.2 may comprise utilisation or consideration of the absolute values of the behavioral parameters being analyzed for statistically significant differences compared to corresponding behavioral parameters of other players, or of the absolute values of related behavioral parameters.

For example, determining a behavioral risk indicator at step 2.2 based on betting trajectory, that is to say, based on an identified statistically significant increase in the size of bets placed by the first player 2′ over a period of time, may include consideration of the absolute values of the amount spent by the first player 2′ over the calculation period to further validate the significance of the identified betting trajectory.

A similar principal can be used regarding other behavioral parameters, such as by including consideration of absolute amount of time spent gambling, the absolute amount of bets made or wagers placed.

In another example, determining a behavioral risk indicator at step 2.2 based on change in tonality of communications, that is to say, based on an identified statistically significant change in the tonality interactions between the first player and call center staff over a period of time, may include consideration of the number of interactions which took place during this period so as to further validate the identified change in tonality.

Moreover, determining a behavioral risk indicator at step 3.2 based on the first player's betting intensity, that is to say, based on an identified statistically significant difference in the betting intensity of the first player 2′ over a period of time compared to the average behavior of other players of their category over a similar period of time, may include consideration of the absolute values of the amount spent by the first player 2′ over the calculation period to further validate the significance of the identified betting intensity difference.

Furthermore, step 2.3 may comprise comparing the first player's profile 20′ with player profiles 21′ of player's listed 32 as being at-risk to determine whether similarities exist between peer-based behavioral risk indicators of the first player 2′ and peer-based behavioral risk indicators of the at-risk players.

The method of FIG. 2 may include the assessment server 4 determining a behavioral risk score for the first player 2′ based on the first player's determined behavioral risk indicators and/or on the first player's determined peer-based behavioral risk indicators.

The aforementioned automatic sending of questions to the first player 2′ in response to the determination of behavioral risk indicators may comprise sending the questions only when the determined behavioral risk score for the first player 2′ exceeds a certain threshold score.

Moreover, the assessment server 4 may select specific questions from the question bank 31 based on the first player's 2′ determined behavioral risk score.

Furthermore, step 2.3 may only occur if the determined behavioral risk score exceeds a certain threshold score. Moreover, step 2.3 may comprise determining similarities between the determined behavioral risk score of the first player 2′ and determined behavioral risk scores of the player profiles 21′ of listed 32 at-risk players.

The method of FIG. 2 may also include the assessment server 4 determining an overall risk score for the first player 2′ based on the first player's behavioral risk score, response risk score and/or the determined likelihood of the first player 2′ self-excluding.

The method of FIG. 2 may include the assessment server 4 performing the initiation of one or more actions of step 2.5 in response to identifying one or more behavioral risk indicators. In this case, the configuration of the one or more actions, such as the selection and/or configuration of the messages at step 2.6, may be based on the first player's 2′ behavioral risk indicators, peer-based behavioral risk indicators and/or behavioral risk score.

The method of FIG. 2 may include the assessment server 4 performing the initiation of one or more actions of step 2.5 in response to identifying one or more similarities between the information relating to the first player's behavior and information relating to the behavior of the listed 32 at-risk players. In this case, the configuration of the one or more actions, such as the selection and/or configuration of the messages at step 2.6, may be based on the first player's 2′ behavioral risk indicators, peer-based behavioral risk indicators, behavioral risk score and/or the aforementioned determined similarities.

The configuration of the one or more actions of step 2.5, such as the selection of a message from the message bank 33a at step 2.6, may alternatively or additionally be based on the first player's 2′ behavioral risk indicators, peer-based behavioral risk indicators, behavioral risk score, response risk indicator/score and/or their determined overall risk score.

For example, the following message may be selected from the message bank 33a when a behavioral risk indicator of a statistically significant increase in losses is identified, and when it is determined that there is a strong likelihood that the first player 2′ will self-exclude in the near future: “Did you know that your most recent gaming is significantly different to how you have typically played? Specifically, did you know that in your last few sessions you have been losing significantly larger amounts of money compared with how you typically bet?”

The message bank 33a may comprise multiple levels of messages. Moreover, the above description of selecting and sending a message may comprise selecting and sending one or more messages from a first level initially, and wherein these initial one or more messages may be followed in sequence by one or more messages from subsequent sequential message levels. For example, a first level message may be configured to provide a player 2 with a risk rating, such as their determined behavioral risk score, response risk score, determined likelihood of self-excluding and/or overall risk score, and a broad description of the risk rating. Moreover, a second level message may be configured to provide the player 2 with more information explaining the risk rating provided in the first level message, for example by highlighting the player's identified behavioral risk indicators. Furthermore, a third level message may be configured to cause the player 2 to address their identified risk behaviors by modifying their behavior. All the different levels of messages may provide links, such as hyperlinks, to other areas of the portal 26, 30 designed to help a player modify their behavior. For example, messages may provide links to other responsible gambling features that the gambling operator or the gambling system 3 provides for the players 2, such as self-exclusion features and limit setting. For instance, the links may take a player 2 to areas of the player portal 26, 30 to allow the player to modify their player account parameters, such as by setting gambling limits.

Before sending a selected message, the assessment server 4 may further configure the message based for example on the same information upon which selection of the message took place. The messages for a player 2′, 2 may also be personalised by the assessment server 4 using any other information from the player's profile 20′, 21′.

Alternatively or additionally, selecting a message from the message bank 33a may comprise the assessment server 4 compiling a message based on an algorithm.

The one or more actions described above comprise the steps of selecting 2.6 and sending 2.7 one or more messages to the first player. However, step 2.5 may comprise initiating one or more actions in addition to or instead of those of steps 2.6 and 2.7. For example, as illustrated by step 3.4 of FIG. 3, the method of FIG. 2 may include the actions of making or affecting one or more changes to services 7 and/or communications provided to the first player 2′ by the gambling system 3 or the gambling operator based on the risk information determined by the assessment server 4, such as the likelihood of the first player 2′ self-excluding, the first player's overall risk score and/or any other determined risk indicators and/or scores described above. Examples of such changes are described below. The examples described below may be implemented in combination with each other. The changes may be made as a result of instructions sent from assessment server 4 to the operator server 5, or by the operator server 5 implementing the changes independently or automatically in response to receiving the risk information from the assessments server 7.

In a first example, the method of FIG. 2 may include changing the responsible gaming settings of the first player's account. For example, if the risk information determined by the assessment server 4 indicates that the first player 2′ is likely to self-exclude in the near future, or if the player shows other strong signals associated with problem gambling, the operator server 5 may exclude the first player 2′ from using the gambling services 7, or from using any services (e.g. websites) or facilities provided by the gambling operator. Alternatively or additionally, the operator server 5 may implement pre-defined limits on the first player 2′ in terms, such as deposit limits, session/game-play time limits and/or loss limits, if their risk information indicates them to be likely to self-exclude, or if the player shows other strong signals associated with problem gambling. Or alternatively the operator server 5 may request the first player 2′ sets their own limits if they have not already done so, if the risk information determined by the assessment server 4 indicates that the first player 2′ is likely to self-exclude in the near future, or if the player shows other strong signals associated with problem gambling. The operator server 5 may also lower or remove previously defined limits if the first player's behaviors are indicated as having moved to a lower risk category by the risk information determined by the assessment server 4.

In a second example, the method of FIG. 2 may include changing the first player's 2′ experience by altering the amount or type of information they receive comprising marketing information which might encourage them to increase their gambling or to otherwise adopt unsustainable gambling behaviors. In more detail, if the risk information determined by the assessment server 4 indicates that the first player 2′ is likely to self-exclude or if the player shows other strong signals associated with problem gambling, the operator server 3 may reduce the amount of, or alter the type of, marketing information displayed to the first player when they use the services, including the gambling services 7, of the gambling system 3, such as when they use the EGMs 13, when they use the network portal 26, 30 and/or when they receive communications from the gambling operator or the assessments server 7 via email or SMS. For example, if the risk information indicates that the first player 2′ is significantly likely to self-exclude in the near future, then the first player 2′ may be excluded from receiving any marketing information. Altering of the type of marketing information may be based on the behavioral risk profile of the player in question. For example, a player 2 who is showing behavioral risk indicators such as a high level of bet intensity would be excluded from cross-sell marketing of games 7 provided by the gambling system 3 that are continuous and that allow bets to be placed with short intervals (e.g. casino-style games), as these types of games can exacerbate that particular risk behavior shown by the player 2. Likewise, a player 2 showing decreasing or low risk levels could result in the gambling system 3 initiating more marketing messages to stimulate gambling given the player's risk category is considered low risk.

In a third example, the method of FIG. 2 may include changing the first player's 2′ experience by altering the amount of gifted or bonus money they receive from the gambling system 3. Such gifted or bonus money would typically be provided to a player 2 by the gambling system 3 in the form of bonuses credit(s). In more detail, if the risk information determined by the assessment server 4 indicates that the first player 2′ is likely to self-exclude or if the player shows other strong signals associated with problem gambling, the operator server 5 may change which bonuses are sent to the first player 2′ based on their behavioral risk profile. For example a player who has a strong statistical trend of increasing the amount of money wagered over a period time would automatically be excluded from ‘deposit bonus’ offers from the gambling system 3, as depositing real-money is a behavior that would possibly exacerbate this risk behavior.

For simplicity, step 2.2 is shown in FIG. 2 as occurring in sequence before steps 2.3 to 2.6. In this case, the system 1 may be configured such that steps 2.3 onwards of the method of FIG. 2 only occur if one or more risk factors are identified.

Alternatively, step 2.2 may occur in parallel to steps 2.3 and 2.4, wherein both step 2.2 and steps 2.3 and 2.4 can be followed by step 2.5. In this respect, the identified behavioral risk indicators of the first player 2′ which, as described above, may be used at step 2.3, may comprise behavioral risk indicators identified during a previous execution of the method of FIG. 2. Moreover, the first player's 2′ question responses and/or their identified response risk indicators which, as described above, may be used at step 2.3, may comprise question responses and/or their identified response risk indicators determined during a previous execution of the method of FIG. 2. Furthermore, the peer-based behavioral risk indicators of the first player 2′ which, as described above, may be used at step 2.3, may comprise peer-based behavioral risk indicators of the first player 2′ determined during a previous execution of the method of FIG. 2. Also, the determined behavioral risk score of the first player 2′ which, as described above, may be used at step 2.3, may comprise a determined behavioral risk score of the first player 2′ determined during a previous execution of the method of FIG. 2.

Similarly, steps 2.2, 3.1, 3.2, 2.3, 3.3 and 2.4 of FIG. 3 are shown as occurring in sequence. However, alternatively, steps 2.2, 3.1 and 3.2 may occur in parallel to steps 2.3, 3.3 and 2.4, both followed by step 2.5. Moreover, step 2.2 may occur in parallel to steps 3.1 and 3.2. Similarly, step 2.3 may occur in parallel to step 3.3, wherein both steps 2.3 and 3.3 can be followed by step 2.4. Furthermore, steps 2.6 and 2.7 may occur in parallel to step 3.4.

The information 22, 22′ relating to a player's behavior may be referred to as player behavior information 22, 22′ or information 22, 22′ on a player's behavior.

The information 23, 23′ on behavior directly related to gambling may be referred to as gambling behavior information 23, 23′, information 23, 23′ on gambling related behavior or information 23, 23′ on gambling behavior.

The other information 24, 24′ relating to a player's behavior may be referred to as non-gambling behavior information 24, 24′ or information 24, 24′ on behavior that's not directly related to gambling.

The player profile 20, 21, 20′, 21′ stored for any one player 2 may be regarded as comprising the following subsets of data:
Gambling data, comprising the following subsets of data:
   Player data, comprising information identifying the player, registration information relating to the player's registration for use of services of the gambling operator, demographic information such as the gender and date of birth of the player and information identifying a player marketing segment to which the player has been determined by the operator as belonging to;
   Game data, comprising the information relating to game-play by the played on the gambling operator's server 3, such as the game session unique identifier, the session start time and finish time, the game name and unique identifier, the amount of real-money wagered during the game, the amount of bonus money wagered during the game, the amount won/lost, etc;
   Transactional data, comprising data relating to how the player deposits real money in his/her account that sits on the gambling operator's server 3, which includes the source of deposits (e.g. credit card, debit card, etc) and whether any transactions have been declined by the first user's bank; and
   Limits data, comprising data relating to the responsible gaming limits that have been set by the player in his/her account in the gambling operator's server 3, such as self-exclusion start/end time dates, deposit limits and which period this relates to (e.g. daily, weekly, monthly, etc), loss limits, etc; and
Non-Gambling Data, comprising information about the player that could be relevant in the context of behavioral analysis and which does not belong to any of the data subsets of gambling data as described above. Such data could include data relating to the player's communications with the gambling operator (either observed by the gambling operator staff in a casino land venue for example, via telephone, online chat rooms and messaging and email), and also data relating to the player that is held by third parties and is legally acquirable by the gambling operator e.g. player credit agency scores, social media data relating to the player, medical records (subject to consent being provided by the user), etc.

Players 2 identified as having a high likelihood of self-excluding, or identified as having a high overall risk score may suffer from one or more forms of problem gambling, such as clinical pathological gambling. The method and apparatus described above may be used to provide therapy for, or to treat, such problem gambling disorders or players before they develop a problem gambling disorder.

The system 1 can perform monitoring behavioral change of a player 2 when the player is known to the system or when the player is anonymous. Anonymous play typically relates to play on physical gaming machines 13, 16 where a player doesn't need to have an account or doesn't use a loyalty card.

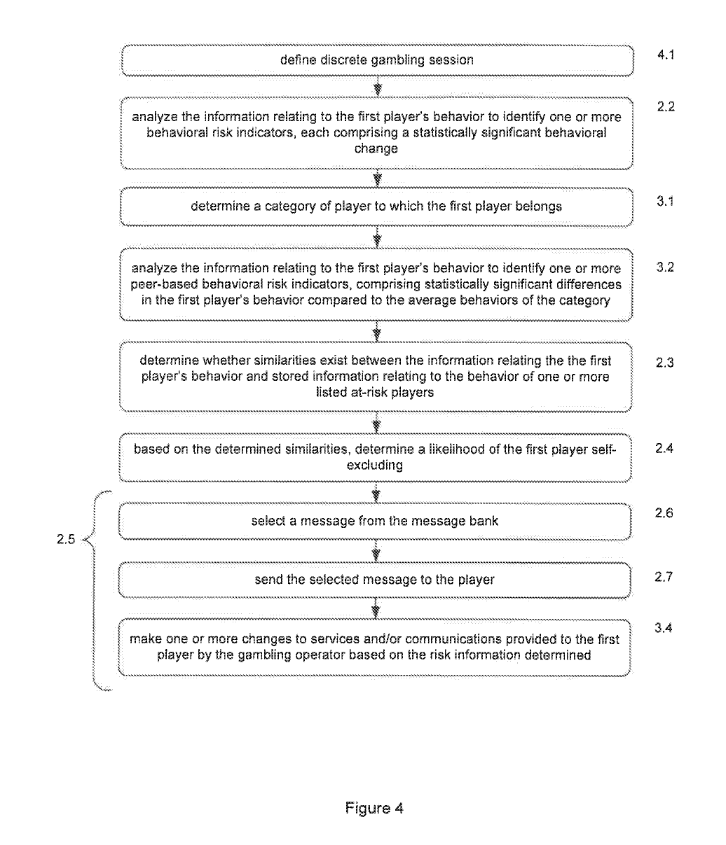

FIG. 4 illustrates operation of the system 1 of FIG. 1 with regard to anonymous play by a player 2. The method of FIG. 4 comprises all but steps 2.1 and 3.3 of FIG. 3, with the only difference being that instead of these steps being performed in relation to the first player, they are performed in relation to an anonymous player. Moreover, any action initiated at step 2.5 will only be implemented via the gambling service 7 being used by the player. Alternatives and variations described above with reference to the method steps of FIG. 3 also apply to these steps as implemented in the method of FIG. 4. Initially a discrete gambling session is defined at step 4.1, and this is based on analysing things such as whether the starting balance in the machine 13 is zero, indicating that the previous player 2 has finished or cashed out, and/or the time from the last spin on the machine 13 being greater than 60 seconds for example, indicating a period where the play is not continuous. Alternatively, the discrete gambling session may be defined based on a player 2 inserting cash into an EGM in order to start an unregistered play session. The player starts to play and the system 1 captures data points throughout the play session. Once sufficient data points are obtained, then steps 2.2 to 3.2 are implemented to analyse patterns and behavior change in the session in real time. Where a statistically significant result is triggered, or the behavior is deemed excessive in comparison to the average/norm for the player's category (e.g. 99^{th} percentile for bet intensity), then the actions of steps 2.3 to 2.5 are implemented.

The system 1 of FIG. 1 has been described above as using self-exclusion as a proxy, or indicator, for a player being at-risk of having or developing a gambling problem. However, other proxies or indicators may instead or additionally be used. For example, reaching a high score on the PGSI based on an assessment of a player's responses to questions provided at step 2.3 may be used as an indicator that a player is at-risk. For example, in this case, step 2.4 would comprise determining a likelihood that the player would reach a high score on the PGSI in the near future, and the actions of step 2.5 would be configure to change a player's behavior so as to avoid their reaching a high score on the PGSI.

Steps 2.3 and 2.4 may for example be performed using other statistical classification techniques, such as non-parametric analysis, artificial neural network techniques, random forest decision trees, or Bayesian theory, or by use of clustering techniques, such as hierarchical or k-means. The statistical analysis may also involve Wald statistics or LR tests to describe the average effects of each predictor variable to the outcome using confidence intervals. For instance, the model may permit conclusions of the following type: “A determined 31% increase in average bet quantity increases the odds that the player 2 Will self-exclude in the future by 21% (with 95% confidence that this average figure lies between 20% and 23%). Moreover, the assessment server 4 may be configured such that the technique or techniques used by the assessment server at steps 2.3 and 2.4 are configurable, for example, by commands from the operator server 5.

The above described functions of the operator server 5 and the assessment server 4 may be performed by a single server.

The network portal 30 provided by the assessment server's 7 may be distinct and separate from, rather then integrated within, the network portal 26 provided by the operator server 5.

The network 27 may for example be the internet. Moreover players' 2 computing devices 8 may access the network 27 wirelessly, for example via a wireless local area network (WLAN) connection.

Information 22, 22′ relating to the behavior of a player 2 can comprise a diversity of different types of data points and contexts. For example, a data point may be configurable and may take the form of a single wager or bet, the aggregated wagers or bets in a single session, or the aggregated wagers or bets in a defined calendar period such as a gambling day, a gambling week or a time-based period such as a five or ten minute period. Analysis of a player's 2 behavioral data may comprise analysis of all of the data points stored for the player 2, or may comprise analysis of certain portions of the data, such as data pertaining to the last 31 days or data pertaining to the last 31 days of gambling activity. Moreover, the portions of the stored data on a player 2 which are used by the assessment server 4 at the various steps of the method of FIGS. 2, 3 and 4 may be configurable, for example by commands from the operator server 5.

In addition, the parameters in the assessment server 4 that are used to determine behavioural risk indicators, and/or which define the various thresholds discussed above, may be configurable. For example, they may be configured based on testing using historical player data stored on the operator server 5 and memory ii and research evidence relating to disordered gambling, both globally applicable and also relating specifically to the jurisdiction where the play is undertaken. For example, the assessment server 4 can be configured to flag statistically significant behavioral changes at any threshold deemed appropriate. For example, this allows a first gambling operator to set the threshold for flagging behavioral change at a different level to that used by a different second gambling operator. Also, the thresholds for determining a behavioural risk indicator can be configured to take into account the game type. For example, the scoring algorithm may be configurable, in that the parameters flagging behavioral change can be calibrated so that certain behaviors provide a greater contribution to the overall risk scoring to account for different game characteristics. For example, because casino games are continuous games and faster than other types of games (e.g. Poker), in terms of the number of rounds or games that can be played in a period, the assessment server 4 can be configured to lower the thresholds for flagging the specific behavioral indicator of a significant increase in betting intensity (number of bets or wagers placed). Alternatively, for lottery, one might not consider betting intensity as the most important behavioral factor; however changes in betting frequency (how often someone returns to gamble or wager) of lottery ticket purchases by a player 2 might be considered a more relevant risk factor to track, hence the threshold for flagging betting frequency as a behavioural risk indicator may be lowered compared to that for flagging betting intensity. Moreover, with regard to the above described use of absolute values in determining behavioral risk indicators, the absolute values used may also be configurable. For example, to allow for configuration based on factors such as peer-reviewed research, jurisdiction and game type.

The assessment server 4 may also be configured to provide services via the network portal 26, 30 by which individuals associated with the gambling operator, such as staff tasked with managing the gambling operator's responsible gaming services, can adjust and/or configure the operation of the assessment server 4. For example, this may allow gambling operator staff to configure the portions of the stored data on a player 2 which are used by the assessment server 4 at the various steps of the method of FIGS. 2, 3 and 4.

The invention has been described above in the context of a risk activity comprising gambling. However, the skilled person will understand that the invention may be applied in the context of other risk activities. For example, the invention may be applied in the context of stock market investment activities. In this case, the above described functions of the operator server 5 might instead be carried out by a server operated by a stockbrokerage and the above described players 2 might instead take the form of investment clients. Moreover, the assessment server 4 would be configured to determine a likelihood that an investment client 2 might start to exhibit unsustainable investment behavior. In a further example, the invention may be applied in the context of social gaming, such as casino-style social games, which are gambling-style games, but without the regulated gambling aspects. In this case, the above described functions of the operator server 5 might instead be carried out by a server operated by a social casino game operator and the above described players 2 might instead take the form of social gamers. Moreover, the assessment server 4 would be configured to determine a likelihood that the social game play client 2 might start to exhibit unsustainable playing behavior which could lead to negative financial, personal, and social consequences. In a further example, the invention may be applied in the context of assessing retail banking. In this example, the proxy for defining at-risk behavior may relate to customers who experience financial difficulty, e.g. using the likelihood of a customer defaulting on a loan payment or going over-drawn on their current account.

Players' 2 computing devices 8 may each access the network portals 26, 30 using an application installed and operating on each of the computing devices 8. Alternatively, the computing devices 8 may each comprise one or more applications providing the above described functions of the network portals 26, 30.

The messages stored in the message bank 33a, and the logic by which the one or more actions are configured by the assessment server 4, may be configurable by the operator server 5.

The method of FIG. 2 is described above as being performed by the assessment server 4. However, the method may alternatively be performed by a player's 2 computing device 8. For example, above described functions of the assessment server 4 in relation to a player 2 may be performed by the computing device 8 of that player 2, and instead of providing the network portal 30, the computing device 8 may simply provide the above described services of the network portal 30 to the player 2 directly via the user interface 9 of the device 8.

The system can either perform periodic analysis or real-time analysis. In more detail, the system can analyse behavioral changes of a player 2, and make appropriate interventions, either by analysing the player's 2 behavioral data periodically (e.g. daily) or as and when the player 2 is playing (real-time).

The network portal 26 is described above as being configured such that it enables communications with players 2 and allows players 2 to set and adjust parameters of their player accounts stored on the gambling system 3, such as setting self-imposed betting limits or initiating a self-exclusion period. Moreover, it is described above that when a player 2 alters these gambling parameters, this behavior is stored in the player's respective player profile 20, 21 as information 23 on behavior directly related to gambling. The gambling system 3 may be configured to provide the same functionality via one or more of the services 7. For example, the gambling system 3 may be configured such that it allows players 2 to set and adjust, via the EGMs and/or VLTs, parameters of their player accounts stored on the gambling system 3, such as setting self-imposed betting limits or initiating a self-exclusion period. Moreover, when a player 2 alters these gambling parameters via the EMGs and/or VLTs, this behavior is stored in the player's respective player profile 20, 21 as information 23 on behavior directly related to gambling.

The various embodiments described above/herein facilitate a number of improvements.

The system 1 allows gambling operators to identify and protect vulnerable players 2, such as by messaging them so as to educate the players 2 regarding their behavior and so as to both prompt and enable them to make more informed decisions about how they should be managing their game play. The system 1 can be an invaluable tool for helping prevent those gamblers showing the early signs of developing problem or disordered gambling behaviors from reaching the point at which they start causing harm. Furthermore, significantly, the apparatus of system 1 enables these advantages to be realised in real-time, as a player's 2 gambling behavior is occurring.

Many modifications and variations of the embodiments of the invention described herein are possible within the scope of the claims hereinafter. Furthermore the particular naming of the components, capitalization of terms, the attributes, data structures, or any other programming or structural aspect is not mandatory or significant, and the mechanisms that implement the invention or its features may have different names, formats, or protocols. Further, the processes described herein may be implemented via a combination of hardware and software, or entirely in hardware or software. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of symbolic representations of operations on information. These representations are the means used by those skilled in the data processing arts to most effectively convey the substance of their work to others skilled in the art. These operations, while described functionally or logically, are understood to be implemented by computer programs. Furthermore, the reference to these operations in terms of modules or software applications should not be considered to imply a structural limitation and references to functional names is by way of illustration and does not infer a loss of generality.

Unless specifically stated otherwise as apparent from the description above, it is appreciated that throughout the description, discussions utilizing terms such as “processing” or “receiving” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a software application. It should be understood that the process steps, instructions, of the present invention as described and claimed, are executed by computer hardware operating under program control, and not mental steps performed by a human. Similarly, all of the types of data described and claimed are stored in a computer readable storage medium operated by a computer system, and are not simply disembodied abstract ideas.

1. A method provided by a computer and comprising:
receiving information relating to a first user's behavior, thereby giving rise to a first behavior information;
analyzing the first behavior information to identify one or more first behavioral risk indicators indicative of statistically significant changes in behavior of the first user; and
when the identified one or more first behavioral risk indicators meet predefined risk criteria, initiating one or more actions configured to cause the first user to change behavior in the risk activity.

2. The method of claim 1, wherein the one or more first behavioral risk indicators meet the predefined risk criteria when their respective values exceed predefined thresholds.

3. The method of claim 1, further comprising:
obtaining one or more at-risk behavioral risk indicators indicative of statistically significant changes in behavior of a second user considered as being at-risk; and
assessing the first behavioral risk indicators as meeting the predefined risk criteria when exist similarities between the first behavioral risk indicators and the at-risk behavioral risk indicators.

4. The method of claim 1, further comprising:
obtaining one or more averaged at-risk behavioral risk indicators indicative of averaged statistically significant changes in behavior of one or more users considered as being at-risk; and
assessing the first behavioral risk indicators as meeting the predefined risk criteria when exist similarities between the first behavioral risk indicators and the averaged at-risk behavioral risk indicators.

5. The method of claim 4, further comprising identifying, among the one or more of users considered as being at-risk, users with similarities in demographic information with the first user's; and
obtaining the one or more averaged at-risk behavioral risk indicators by averaging over behavior information related merely to the identified users.

6. The method of claim 1, further comprising:
receiving second behavior-relating information for each user from a plurality of users;
identifying, among the plurality of users, one or more second users with existing similarity between respective second behavior information and the first behavior information;
obtaining one or more averaged behavioral risk indicators indicative of averaged statistically significant changes in behavior of the identified one or more second users; and
assessing the first behavioral risk indicators as meeting the predefined risk criteria in accordance with similarities between the first behavioral risk indicators and the averaged behavioral risk indicators.

7. The method of claim 1 further comprising:
receiving from the first user responses on one or more questions;
identifying one or more second users with existing similarity between their stored responses on the same one or more questions and the respective responses from the first user;
obtaining one or more averaged behavioral risk indicators indicative of averaged statistically significant changes in behavior of the identified one or more second users; and
assessing the first behavioral risk indicators as meeting the predefined risk criteria in accordance with similarities between the first behavioral risk indicators and the averaged behavioral risk indicators.

8. The method of claim 1, wherein the initiating one or more actions comprises providing to the first user one or more messages configured to cause the first user to change behavior in the risk activity.

9. The method of claim 6, wherein providing one or more messages comprises displaying the one or more messages on a display for viewing by the user.

10. The method of claim 1, further comprising using the identified one or more first behavioral risk indicators to determine likelihood of the first user exhibiting the behavior in the risk activity being above a threshold likelihood.

11. The method of claim 8, wherein the one or more actions are configured based on the determined likelihood of the first user exhibiting the behavior in the risk activity.

12. The method of claim 1, wherein:
the first information comprises information on behavior related to gambling;
the one or more risk indicators each indicative of a statistically significant behavioral change considered to be associated with problem gambling; and
the risk activity comprises gambling.

13. An apparatus comprising at least one processing device operatively connected to at least one memory, the processing device and the memory configured to:
receive information relating to a first user's behavior, thereby giving rise to a first behavior information;
analyze the first behavior information to identify one or more first behavioral risk indicators indicative of statistically significant changes in behavior of the first user; and
when the identified one or more first behavioral risk indicators meet predefined risk criteria, initiate one or more actions configured to cause the first user to change behavior in the risk activity.

14. The apparatus of claim 13, wherein the one or more first behavioral risk indicators meet the predefined risk criteria when their respective values exceed predefined thresholds.

15. The apparatus of claim 13, wherein the processing device and the memory are further configured to:
obtain one or more at-risk behavioral risk indicators indicative of statistically significant changes in behavior of a second user considered as being at-risk; and
assess the first behavioral risk indicators as meeting the predefined risk criteria when exist similarities between the first behavioral risk indicators and the at-risk behavioral risk indicators.

16. The apparatus of claim 13, wherein the processing device and the memory are further configured to:
obtain one or more averaged at-risk behavioral risk indicators indicative of averaged statistically significant changes in behavior of one or more users considered as being at-risk; and
assess the first behavioral risk indicators as meeting the predefined risk criteria when exist similarities between the first behavioral risk indicators and the averaged at-risk behavioral risk indicators.

17. The apparatus of claim 16, wherein the processing device and the memory are further configured to identify, among the one or more of users considered as being at-risk, users with similarities in demographic information with the first user's; and
obtain the one or more averaged at-risk behavioral risk indicators by averaging over behavior information related merely to the identified users.

18. The apparatus of claim 13, wherein the processing device and the memory are further configured to:
receive second behavior-relating information for each user from a plurality of users,
identify, among the plurality of users, one or more second users with existing similarity between respective second behavior information and the first behavior information;
obtain one or more averaged behavioral risk indicators indicative of averaged statistically significant changes in behavior of the identified one or more second users; and
assess the first behavioral risk indicators as meeting the predefined risk criteria in accordance with similarities between the first behavioral risk indicators and the averaged behavioral risk indicators.

19. The apparatus of claim 13, wherein the processing device and the memory are further configured to:
receive from the first user responses on one or more questions;
identify one or more second users with existing similarity between their stored responses on the same one or more questions and the respective responses from the first user;
obtain one or more averaged behavioral risk indicators indicative of averaged statistically significant changes in behavior of the identified one or more second users; and
assess the first behavioral risk indicators as meeting the predefined risk criteria in accordance with similarities between the first behavioral risk indicators and the averaged behavioral risk indicators.

20. A non-transitory computer readable medium comprising instructions that, when executed by a processing device, cause the processing device to:
receive information relating to a first user's behavior, thereby giving rise to a first behavior information;
analyze the first behavior information to identify one or more first behavioral risk indicators indicative of statistically significant changes in behavior of the first user; and
when the identified one or more first behavioral risk indicators meet predefined risk criteria, initiate one or more actions configured to cause the first user to change behavior in the risk activity.
